(19) United States
(12) Patent Application Publication
(10) Pub. No.: US 2014/0147662 A1
(43) Pub. Date: May 29, 2014

(54) HARD COAT FILM

(71) Applicant: SONY CHEMICAL & INFORMATION DEVICE CORPORATION, Tokyo (JP)

(72) Inventors: Kentaroh ISHIKAWA, Tochigi (JP); Ikuo KAKEFUDA, Tochigi (JP); Shinichi MATSUMURA, Tochigi (JP)

(73) Assignee: SONY CHEMICAL & INFORMATION DEVICE CORPORATION, Tokyo (JP)

(21) Appl. No.: 14/171,560

(22) Filed: Feb. 3, 2014

Related U.S. Application Data
(63) Continuation of application No. 12/733,555, filed on Mar. 8, 2010, now abandoned.

(30) Foreign Application Priority Data
Sep. 26, 2007 (JP) 2007-249043

(51) Int. Cl. C09D 133/04

(52) U.S. Cl. CPC C09D 133/04
USPC 428/331; 428/423.1; 428/339; 524/493

(57) ABSTRACT

A high-hardness hard coat film having a reduced degree of curling and an ionizing ray polymerizable resin composition for forming the hard coat layer of such a hard coat film are provided. The hard coat film includes a resin film and a hard coat layer disposed on the surface of the resin film. The hard coat layer is formed of a cured product of a photopolymerizable composition containing an acrylic component, a hyperbranched acrylate resin, a silicone component, and silica particles. The cured product is produced by exposure to ionizing rays.

This is a Continuation of application Ser. No. 12/733,555 filed Mar. 8, 2010, which in turn is a National Phase Application of PCT/JP2008/067342 filed on Sep. 25, 2008, which claims the benefit of Japanese Patent Application No. 2007-249043 filed Sep. 26, 2007. The disclosure of the prior applications is hereby incorporated by reference herein in its entirety

### TECHNICAL FIELD

The present invention relates to an ionizing ray polymerizable resin composition for forming a hard coat layer used as a protective layer for the surfaces of displays such as CRTs, LCDs, PDPs, FEDs, and organic EL devices, touch panels of home electric appliances, glass, and the like and also relates to a hard coat film used as a protective film therefor.

### BACKGROUND ART

Recently, plastic products are replacing glass products because of their workability and light weight. However, the surfaces of such plastic products do not resist scratches. Therefore, a hard coat film is often applied to their surfaces to impart scratch resistance thereto.

Also, conventional glass products are frequently covered with a plastic film to prevent shattering. To improve the surface hardness of such a plastic film, a hard coat layer is generally formed on the surface of the plastic film.

In conventional hard coat films, the hard coat layer is typically formed as follows. First, a coating containing a thermosetting resin or an active energy ray polymerizable resin such as a UV curable resin is applied to a substrate (for example, triacetylcellulose film) directly or with a primer layer of about 1 μm interposed therebetween to form a thin coating layer of less than about 10 μm. Subsequently, heat or light is applied to the coating layer to cure the coating, whereby the hard coat layer is formed.

However, the hardness of the hard coat layer of such a conventional hard coat film is insufficient. In addition, when the substrate is deformed, the hard coat layer is deformed accordingly, and therefore the hardness of the hard coat film as a whole is low. Therefore, such a conventional hard coat film is not fully satisfactory.

For example, a hard coat film formed by applying a UV curable coating to a triacetylcellulose film to the above thickness (less than about 10 μm) generally has a pencil hardness of 3H or less.

When the hardness of a hard coat film is insufficient, the hardness can be improved by simply increasing the thickness of the hard coat layer to greater than the normal thickness (10 μm). In this manner, a pencil hardness of 4H can be easily obtained. However, disadvantageously, the hard coat layer is easily cracked and peeled off, and the degree of curling caused by curing shrinkage of the coating increases (see Patent Document 1: Japanese Patent Application Laid-Open No. 2000-127281).

Japanese Patent No. 1815116 (Patent Document 2) discloses a coating composition containing: a polyfunctional acrylic ester-based monomer used as the resin-forming component of a hard coat layer; a powder-like inorganic filler such as alumina, silica, or titanium oxide; and a polymerization initiator.

Japanese Patent No. 1416240 (Patent Document 3) discloses a photopolymerizable resin composition containing a mineral charge composed of silica or alumina surface-treated with alkoxysilane or the like. However, even when any of the above compositions is used for the hard coat layer, the surface hardness of the resultant hard coat layer does not satisfy the recent requirement.

When a high-hardness charge such as alumina is added, the resistance to scratching is improved when a scratching load is applied to a relatively large contact area, such as in pencil hardness test. However, in contrast, the resistance to scratching is poor under severe scratching conditions (for example, when the load per unit area is high such as in scratching with a mechanical pencil) because a large number of cracks are formed in the scratch marks.

In the technique proposed in Japanese Patent Application Laid-Open No. 2000-52472 (Patent Document 4), two hard coat layers are provided, and fine silica particles are added to one of the layers to obtain satisfactory curling resistance and scratch resistance. However, this technique is not sufficiently effective.
[Patent Document 1] Japanese Patent Application Laid-Open No. 2000-127281.
[Patent Document 2] Japanese Patent Application Laid-Open No. Sho. 57-74369 (Japanese Patent No. 1815116).
[Patent Document 3] Japanese Translation of PCT International Application No. Sho. 58-500251 (Japanese Patent No. 1416240).
[Patent Document 4] Japanese Patent Application Laid-Open No. 2000-52472.

### DISCLOSURE OF THE INVENTION

### Problems to be Solved by the Invention

It is an object of the present invention to provide a resin composition capable of forming a hard coat layer that has high hardness and resists cracking and curling, and also to provide a hard coat film.

### Means for Solving the Problems

The present inventors have conducted intensive studies and found the following. When a material, such as a polyfunctional acrylic monomer or a polyfunctional oligomer, which is polymerized to form a hard cured product is used as the material for the hard coat layer, the strength is improved, but the degree of curling increases. In contrast, when a material which can reduce the degree of curling is used as the material for the hard coat layer, the strength is impaired.

The present inventors have conducted further studies and found that, when an acrylate resin having a hyperbranched structure is added in addition to the acrylic component such as a polyfunctional acrylic monomer and a polyfunctional oligomer, a hard coat film having high hardness and improved resistance to curling can be obtained.

The present invention is based on the above finding and provides an ionizing ray polymerizable resin composition for forming a hard coat layer, the composition comprising:

65.0 parts by weight or more and 95 parts by weight or less of an acrylic component including one or both of a polyfunctional acrylic monomer and a polyfunctional acrylic oligomer having a linear main skeleton or a main skeleton having one branch point;

0.5 parts by weight or more and 12 parts by weight or less of a silicone component including one or both of a silicone monomer having an acryloyl group at a terminal thereof and a silicone oligomer having an acryloyl group at a terminal thereof;

2.0 parts by weight to 20.0 parts by weight or less of a hyperbranched acrylate resin having 2 or more branch points in a main skeleton thereof and having 9 or more and 16 or less functional groups in a chemical structure thereof; and

0.5 parts by weight or more to 6.0 parts by weight of silica particles.

The present invention also provides a hard coat film, comprising a resin film and a hard coat layer disposed on a surface of the resin film, wherein

the hard coat layer is a cured product of an ionizing ray polymerizable resin composition, the cured product being produced by curing the ionizing ray polymerizable resin composition by exposure to ionizing rays, the ionizing ray polymerizable resin composition comprising:

65.0 parts by weight or more and 95.0 parts by weight or less of an acrylic component including one or both of a polyfunctional acrylic monomer and a polyfunctional acrylic oligomer having a linear main skeleton or a main skeleton having one branch point;

0.5 parts by weight or more and 12.0 parts by weight or less of a silicone component including one or both of a silicone monomer having an acryloyl group at a terminal thereof and a silicone oligomer having an acryloyl group at a terminal thereof;

2.0 parts by weight or more and 20.0 parts by weight or less of a hyperbranched acrylate resin having 2 or more branch points in a main skeleton thereof and having 9 or more and 16 or less functional groups in a chemical structure thereof; and

0.5 parts by weight or more and 6.0 parts by weight or less of silica particles.

One preferred embodiment of the hard coat film of the present invention provides a hard coat film in which the hard coat layer has a thickness of 6.0 μm or more and 12.0 μm or less. Another preferred embodiment of the hard coat film of the present invention provides a hard coat film in which an average particle size of the silica particles is 10 nm or more and 50 nm or less.

### Effects of the Invention

The hard coat layer formed using the ionizing ray polymerizable resin composition of the present invention and the hard coat film of the invention have advantages of high surface hardness, high resistance to scratching, and high resistance to curling. In addition, when the inventive hard coat layer or hard coat film is provided on an image display surface, an image display device including a protective layer having high surface hardness and high scratching resistance can be provided.

### BRIEF DESCRIPTION OF THE DRAWINGS

FIG. 1 is a cross-sectional view illustrating an example of a hard coat film of the present invention.

FIG. 2 is a schematic view describing an example of the chemical structure of a hyperbranched acrylate resin.

FIG. 3 is a schematic cross-sectional view illustrating a state in which the hard coat film is applied to a display device.

### DESCRIPTION OF REFERENCE NUMERALS

10 hard coat film
11 resin film
15 hard coat layer

### BEST MODE FOR CARRYING OUT THE INVENTION

An ionizing ray polymerizable resin composition of the present invention contains an acrylic component, a silicone component, a hyperbranched acrylate resin, and silica particles, which will be described later, and, if necessary, further contains additives such as a photopolymerization initiator and a sensitizer.

A polyfunctional acrylic monomer used in the acrylic component has at least two functional groups such as an acryloyl group. In the present invention, the term acryloyl group is used to include a methacryloyl group.

Examples of the polyfunctional acrylic monomer include: polyol polyacrylates such as ethylene glycol di(meth)acrylate, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, and dipentaerythritol hexa(meth)acrylate; epoxy acrylates such as di(meth)acrylate of bisphenol A diglycidyl ether and di(meth)acrylate of hexanediol diglycidyl ether; and urethane acrylates obtained by reacting a polyisocyanate with a hydroxyl group-containing acrylate such as hydroxyethyl(meth)acrylate.

Examples of the polyfunctional acrylic oligomer used in the acrylic component include general oligomers such as polyester acrylates, epoxy acrylates, urethane acrylates, and polyol acrylates. Any oligomer having a linear main skeleton (no branch point) or one branch point in the main skeleton can be selected from the above oligomers.

To impart high hardness through the hard coat layer, it is preferable to use a urethane oligomer as the acrylic component. However, in some applications of the hard coat film, high hardness (for example, a pencil hardness of 4H) is not required. In such a case, no particular limitation is imposed on the acrylic component.

FIG. 2 schematically shows the chemical structure of an example of such a hyperbranched acrylate resin. This hyperbranched acrylate resin has a main skeleton including a plurality of repeating structural units, and the main skeleton has a hyperbranched structure having at least two branch points b.

In FIG. 2, reference symbol R represents a functional group, and each dotted line represents a bond between the functional group R and the main skeleton. As shown by reference symbol a in FIG. 2, each functional group R is bonded to the main skeleton at one point. More specifically, the functional group R is bonded to one particular carbon atom in the main skeleton.

In FIG. 2, the number of the branch points b is 8. However, no particular limitation is imposed on the structure and the number of branch points of the main skeleton of the hyperbranched acrylate resin used in the present invention, so long as the number of branch points b is two or more. An example of the main skeleton of the hyperbranched acrylate resin is a dendritic structure referred to as dendrimer.

A more detailed description will now be given of the hyperbranched acrylate resin. Examples of the hyperbranched acrylate resin include hyperbranched oligomers in which an oligomer composed of at least two monomers serving as repeating structural units bonded together serves as the main skeleton and functional groups such as an acryloyl group are bonded to the oligomer.

The number of the functional groups in the chemical structure of the hyperbranched acrylate resin is 9 or more and 16 or less. When the number of the functional groups is less than 9 or greater than 16, the pencil hardness is reduced, or the degree of curling increases.

No particular limitation is imposed on the type of the functional group. However, at least one of the functional groups bonded to the main skeleton is an acryloyl group.

Any oligomer selected from polyfunctional acrylic oligomers such as polyester acrylates, epoxy acrylates, urethane acrylates, and polyol acrylates may be used as the hyperbranched acrylate resin, so long as it has at least two branch points in the main skeleton.

The difference between the polyfunctional acrylic oligomer used in the acrylic component and the polyfunctional acrylic oligomer used in the hyperbranched acrylate resin is whether the number of branch points in the main skeleton is at least two or not.

The silicone component includes one or both of a silicone monomer having an acryloyl group at its terminal and a silicone oligomer having an acryloyl group at its terminal.

The main skeleton of each of the silicone monomer and the silicone oligomer has a siloxane bond. In the silicone monomer, an acrylic monomer is bonded to the main skeleton. In the silicone oligomer, an acrylic oligomer is bonded to the main skeleton.

The acryloyl group at the terminal of the silicone monomer is the acryloyl group of the acrylic monomer, and the acryloyl group at the terminal of the silicone oligomer is the acryloyl group of the acrylic oligomer.

Examples of the acrylic monomer bonded to the main skeleton of the silicone monomer include the above-exemplified polyfunctional acrylic monomers used in the acrylic component. Examples of the acrylic oligomer bonded to the main skeleton of the silicone oligomer include the above-exemplified polyfunctional oligomers used in the acrylic component.

The polyfunctional acrylic monomer and the polyfunctional acrylic oligomer used in the acrylic component and the polyfunctional acrylic oligomer used in the hyperbranched acrylate resin are different from the silicone monomer and the silicone oligomer used in the silicone component in that they do not have a main skeleton having a siloxane bond.

Examples of the silica particles used in the present invention include colloidal silica, hollow silica, and silica sol.

The average particle size of the silica particles is preferably 10 nm or more and less than 60 nm and particularly preferably 10 nm or more and 50 nm or less. When the particle size of the silica particles is 60 nm or more, the transparency, the permanent marker ink repellency, and the ease of wiping fingerprints off are impaired.

Since the addition of the silica particles can increase the surface roughness of the hard coat film to some extent, the handleability of the hard coat film can be improved. Generally, hard coat films are brought to market in a rolled-up state. When a hard coat film including a hard coat layer having an excessively smooth surface is wound into a roll, the adhesive properties between the hard coat layer and the resin film become too high, so that the feeding properties are impaired. Therefore, also in terms of the feeding properties, it is preferable to add the silica particles to the hard coat layer to thereby increase the surface roughness to some extent.

Preferably, an ionizing ray polymerization initiator, in addition to the above components, is added to the ionizing ray polymerizable resin composition, in order to facilitate the polymerization of the acrylic component, the hyperbranched acrylate resin, and the silicone component.

Any general photopolymerization initiator may be used as the ionizing ray polymerization initiator. For example, at least one photopolymerization initiator selected from the group consisting of acetophenones, benzophenones, Michler's ketone, benzoylbenzoate, benzoins, α-acyloxime ester, tetramethylthiuram monosulfide, and thioxanthone may be added.

A photosensitizer may be used in addition to the photopolymerization initiator. When a photosensitizer is added, the polymerization rate is accelerated. No particular limitation is imposed on the photosensitizer. For example, at least one photosensitizer selected from the group consisting of n-butylamine, triethylamine, tri-n-butylphosphine, and thioxanthone may be added.

In the ionizing ray photopolymerizable resin composition, the ratio of the amounts of the above acrylic component, hyperbranched acrylate resin, silicone component, and silica particles is 60 to 95 parts by weight of acrylic component: 2.0 to 20 parts by weight of hyperbranched acrylate resin: 0.5 to 12 parts by weight of silicone component: 0.5 to 6.0 parts by weight of silica particles.

When the amount of the acrylic component is below the above range, the pencil hardness is low. When the amount exceeds the above range, the degree of curling is high.

When the amount of the hyperbranched acrylate resin is below the above range, the degree of curling is high. When the amount exceeds the above range, the pencil hardness is low.

When the amount of the silicone component is below the above range, the pencil hardness is low. When the amount exceeds the above range, the pencil hardness is also low.

When the amount of the silica particles is below the above range, the degree of curling is high. When the amount exceeds the above range, the transparency is impaired.

The amount of the ionizing ray polymerization initiator used is preferably in the range between 0.1 parts by weight or more and 15 parts by weight or less and more preferably in the range between 1 part by weight or more and 10 parts by weight or less based on 100 parts by weight of the total amount of the acrylate-based monomer and oligomer (i.e., the acrylic component), the hyperbranched acrylate resin, and the silicone component.

The ionizing ray polymerizable resin composition is used to form a hard coat layer by applying the resin composition to the surface of a display such as a CRT, LCD, PDP, PED, or organic EL, or the surface of a touch panel of a home electric appliance, glass, or the like, followed by curing. This resin composition is also used to manufacture a hard coat film by applying the resin composition to a resin film to form a hard coat layer.

Examples of the ionizing rays capable of curing the ionizing ray polymerizable resin composition include radioactive rays, gamma rays, alpha rays, electron rays, and ultraviolet rays, and ultraviolet rays are preferred.

The thickness of the hard coat layer is preferably more than 5 μm and less than 13 μm and particularly preferably 6.0 μm or more and 12.0 μm or less. When the thickness of the hard coat layer is 5 μm, the pencil hardness does not reach 4H. When the thickness is 13 μm, the value of the degree of curling measured by a measurement method described later in Examples exceeds 20 mm, and a problem may arise.

No particular limitation is imposed on the resin film used in the hard coat film of the present invention. However, when the hard coat film is applied to the surface of a display or a touch panel or is used as a protective film of glass or the like, it is preferable to use a transparent resin film (a transparent plastic film).

No particular limitation is imposed on the transparent plastic film. Any suitable film selected from known transparent plastic films may be used. Specific examples of the usable transparent plastic film include general purpose films of triacetylcellulose, polyethylene terephthalate, polycarbonate, diacetyl cellulose, polyvinyl chloride, polyester, polyethylene, polypropylene, acetyl cellulose butyrate, polystyrene, and the like. Of these, triacetylcellulose and polyethylene terephthalate are particularly preferred as the hard coat film applied to image display devices and the like because they have high transparency and no optical anisotropy.

No particular limitation is imposed on the thickness of the resin film. When a triacetylcellulose film is used as the resin film, the thickness of the resin film is preferably in the range of from 40 to 500 μm. When the resin film is too thin, the film strength is low. When the resin film is too thick, the hard coat film is too hard and lacks flexibility. Therefore, the thickness of the resin film is more preferably in the range of from 80 to 200 μm.

Next, a description will be given of the process of forming the hard coat layer on the surface of the resin film.

For example, the above acrylic component, hyperbranched acrylate resin, silicone component, and additives (the photopolymerization initiator and photosensitizer) are dissolved in an organic solvent such as ketone-, alcohol-, or ester-based solvent. Then, a dispersion of surface-modified hard inorganic fine particles and a dispersion of soft fine particles are added to the prepared solution, whereby a coating solution of the photopolymerizable resin composition is prepared.

The above dispersion of surface-modified hard inorganic fine particles is, for example, a dispersion prepared by dispersing hollow silica in a solvent. The above dispersion of soft fine particles is a dispersion prepared by dispersing one or both of colloidal silica and silica sol in a solvent.

The coating solution of the photopolymerizable resin composition is applied to the surface of the resin film using a known thin film formation method such as dipping method, spinner method, spray method, roll coater method, gravure method, or wire-bar method to thereby form a coating layer of the photopolymerizable resin composition.

After the coating layer is dried to remove the solvent, the coating layer is irradiated with ionizing rays (active energy rays).

Each of the acrylic component, the hyperbranched acrylate resin, and the silicone component has an acryloyl group in the chemical structure thereof. Therefore, when these materials are irradiated with ionizing rays, the acryloyl group in the acrylic component, the acryloyl group in the hyperbranched acrylate resin, and the acryloyl group in the silicone component are polymerized. Accordingly, the coating layer is cured, and the hard coat layer is formed.

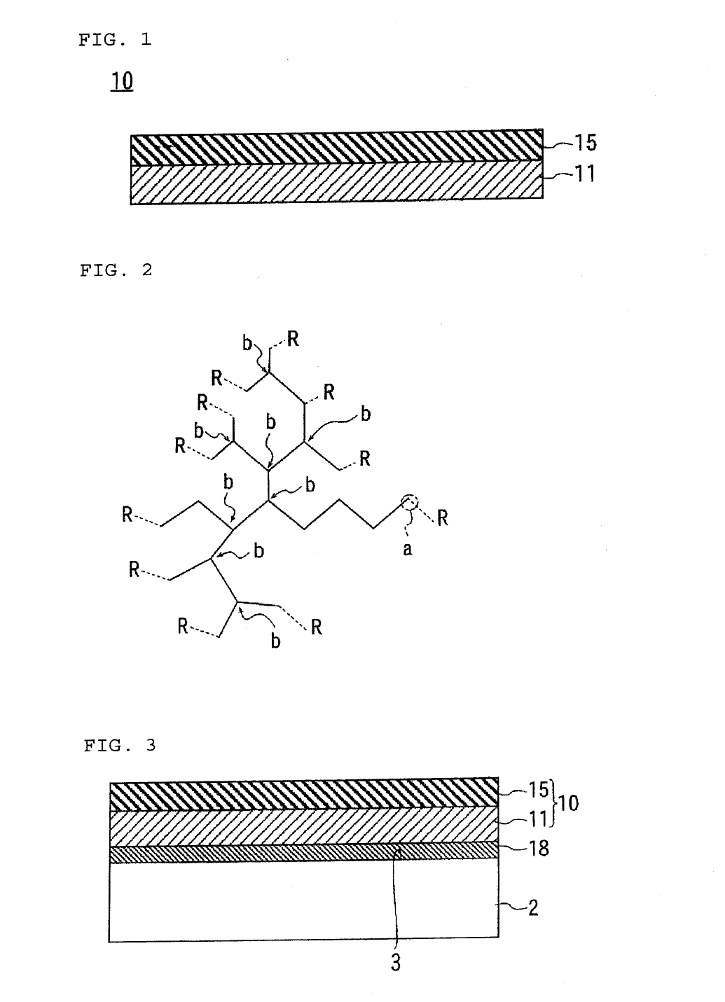

Reference numeral 10 in FIG. 1 represents the hard coat film having the hard coat layer 15 formed on the surface of the resin film 11.

To improve the adhesion properties between the resin film 11 and the hard coat layer 15, one or both surfaces of the resin film 11 may be subjected to surface treatment using oxidation method, roughening method, or other similar method. Examples of the oxidation method include corona discharge treatment, glow discharge treatment, chromic acid treatment (wet treatment), flame treatment, hot-air treatment, and ozone-ultraviolet irradiation treatment.

The hard coat film of the present invention includes films including at least one type of functional film laminated at least one of on the surface of the hard coat layer, between the hard coat layer and the resin film, and on the surface of the resin film which is opposite to the side on which the hard coat layer is disposed.

Examples of the functional film include an antireflective layer, a ultraviolet-infrared absorbing layer, a selected wavelength absorbing layer, an electromagnetic interference shielding layer, and an antifouling layer. The hard coat film including a functional film is provided as a high-hardness functional film. The above functional films may be produced by applying a solution of a known material to the hard coat layer or by vacuum deposition such as sputtering or evaporation.

The hard coat film of the present invention is suitable for a protective film for display devices such as cathode ray tube (CRT) display devices, liquid crystal displays (LCDs), plasma display panels (PDPs), field emission displays (FEDs), and organic EL displays.

Reference numeral 2 in FIG. 3 represents a display device. The display device 2 includes a display plane 3 for displaying letters and images. The hard coat film 10 of the present invention is applied to the display plane 3 with, for example, a transparent adhesive 18 interposed therebetween and serves as a protective film.

### EXAMPLES

### Example 1

Acrylic component: polyfunctional acrylic urethane oligomer (product name: “1290K” available from DAICEL CHEMICAL INDUSTRIES, LTD., the number of functional groups: 6) 38.80 percent by weight

Hyperbranched acrylate resin: hyperbranched oligomer (product name: “CN2302” available from Sartomer Co., Ltd., the number of functional groups: 16) 5.30 percent by weight

Silicone component: silicone oligomer (product name: “CN990” available from Sartomer Co., Ltd.) 2.90 percent by weight

Silica particles of an average size of 30 nm 1.50 percent by weight

Photopolymerization initiator (product name: “Irgacure 184” available from Ciba Specialty Chemicals) 1.50 percent by weight

Solvent (methyl ethyl ketone) 50 percent by weight

A mixed solution having the above composition was stirred for 1 hour using disper, whereby a coating solution was prepared.

In the hyperbranched acrylate resin used in Example 1, the main skeleton is a polyester skeleton having at least two branch points, and 16 acryloyl groups are bonded to the terminals of the main skeleton.

The prepared coating solution was applied to a triacetylcellulose film of 80 μm using a wire bar and was dried in an oven at 70° C. for 1 minute. Subsequently, the dried film was irradiated using a high pressure mercury vapor lamp until the integrated light quantity reached 500 mJ/cm², whereby a hard coat film of Example 1 including a hard coat layer of a thickness of 8 μm was obtained.

### Examples 2 and 3

Hard coat films of Examples 2 and 3 were obtained under the same conditions as in Example 1 except that the bar gage of the wire bar used to apply the coating solution was changed so that the thicknesses of the hard coat layers of the hard coat films of Examples 2 and 3 were 6 μm and 12 μm, respectively.

### Examples 4 to 11 and 19

Hard coat films of Examples 4 to 11 and 19 were produced under the same conditions as in Example 1 except that the coating solutions were prepared using different ratios of the amounts of the acrylic component, hyperbranched acrylate resin, silicone component, silica particles, photopolymerization initiator, and solvent, the ratios being shown in Table 1. The ratios of the amounts of the components in Examples 4 to 11 and 19, the ratios of the amounts of the components in Examples 1 to 3, and also the ratios of the amounts of the components in Examples 12 to 18 described later are listed in Table 1.

TABLE 1
Ratio of amounts of coating solution and photopolymerizable composition (Examples)

| Components | | Ex. | Ex. | Ex. | Ex. | Ex. | Ex. | Ex. | Ex. | Ex. |
|---|---|---|---|---|---|---|---|---|---|---|
| (parts by weight) | | 1-3 | 4 | 5 | 6 | 7 | 8 | 9 | 10 | 11 |
| Coating | Acrylic | 77.60 | 65.00 | 93.34 | 85.32 | 69.70 | 82.11 | 72.66 | 79.66 | 75.95 |
| solution of | component | | | | | | | | | |
| photo- | Hyper- | 10.60 | 17.48 | 2.00 | 2.00 | 19.40 | 11.22 | 9.93 | 10.88 | 10.37 |
| poly- | branched | | | | | | | | | |
| merization | acrylic | | | | | | | | | |
| resin | resin | | | | | | | | | |
| composition | Silicone | 5.80 | 9.57 | 1.09 | 6.38 | 5.21 | 0.50 | 11.60 | 5.95 | 5.68 |
| | component | | | | | | | | | |
| | Silica | 3.00 | 4.95 | 0.57 | 3.30 | 2.69 | 3.17 | 2.81 | 0.50 | 5.00 |
| | particles | | | | | | | | | |
| | (30 nm) | | | | | | | | | |
| | Initiator | 3.00 | 3.00 | 3.00 | 3.00 | 3.00 | 3.00 | 3.00 | 3.00 | 3.00 |
| | (Subtotal) | 100.00 | 100.00 | 100.00 | 100.00 | 100.00 | 100.00 | 100.00 | 100.00 | 100.00 |
| | Solvent | 100.00 | 100.00 | 100.00 | 100.00 | 100.00 | 100.00 | 100.00 | 100.00 | 100.00 |

| Components | | Ex. | Ex. | Ex. | Ex. | Ex. | Ex. | Ex. | Ex. |
|---|---|---|---|---|---|---|---|---|---|
| (parts by weight) | | 12 | 13 | 14 | 15 | 16 | 17 | 18 | 19 |
| Coating | Acrylic | 77.60 | 77.60 | 77.60 | 77.60 | 77.60 | 77.60 | 77.60 | 75.29 |
| solution of | component | | | | | | | | |
| photo- | Hyperbranched | 10.60 | 10.60 | 10.60 | 10.60 | 10.60 | 10.60 | 10.60 | 10.28 |
| poly- | acrylic resin | | | | | | | | |
| merization | Silicone | 5.80 | 5.80 | 5.80 | 5.80 | 5.80 | 5.80 | 5.80 | 5.63 |
| resin | component | | | | | | | | |
| composition | Silica particles | 3.00 | 3.00 | 3.00 | 3.00 | 3.00 | 3.00 | 3.00 | 5.80 |
| | (30 nm) | | | | | | | | |
| | Initiator | 3.00 | 3.00 | 3.00 | 3.00 | 3.00 | 3.00 | 3.00 | 3.00 |
| | (Subtotal) | 100.00 | 100.00 | 100.00 | 100.00 | 100.00 | 100.00 | 100.00 | 100.00 |
| | Solvent | 100.00 | 100.00 | 100.00 | 100.00 | 100.00 | 100.00 | 100.00 | 100.00 |

The ratios of the amounts of the components listed in Table 1 and Table 2 described layer are the ratios of the amount (parts by weight) of each component to the total amount (100 parts by weight) of the acrylic component, hyperbranched acrylate resin, silicone component, silica particles, and photopolymerization initiator in the coating solution of the photopolymerizable composition. In other words, these ratios of the amounts of the components are expressed as percent by weight.

### Examples 12 and 13

Hard coat films of Examples 12 and 13 were produced under the same conditions as in Example 1 except that the average particle size of the silica particles was changed from 30 nm to 10 nm and 50 nm.

### Example 14

A Hard coat film of Example 14 was produced under the same conditions as in Example 1 except that the hyperbranched oligomer (16 functional groups) used as the hyperbranched acrylate resin was changed to a hyperbranched oligomer having 9 functional groups (product name: “CN2301” available from Sartomer Co., Ltd.).

### Example 15

A Hard coat film of Example 15 was produced under the same conditions as in Example 1 except that the material for the resin film was changed from triacetylcellulose to polyethylene terephthalate.

### Examples 16 to 18

Hard coat films of Examples 16 to 18 were produced under the same conditions as in Example 1 except that the polyfunctional acrylic urethane oligomer used as the acrylic component was changed to one having 6 functional groups (product name: “CN9006” available from Sartomer Co., Ltd.), one having 10 functional groups (product name: “UV1700B” available from The Nippon Synthetic Chemical Industry Co., Ltd.), and one having 15 functional groups (product name: “NTX767” available from Sartomer Co., Ltd.).

### Comparative Examples 1 to 7

Hard coat films of Comparative Examples 1 to 7 were obtained under the same conditions as in Example 1 except that the ratio of the amount of the acrylic component, hyperbranched acrylate resin, silicone component, silica particles, photopolymerization initiator, and solvent was changed as shown in Table 2. The compositions of the coating solutions used in Comparative Examples 1 to 7 were listed in Table 2.

TABLE 2
Ratio of amounts of coating solution and photopolymerizable
composition (Comparative Examples)

| Components | | Com | Com | Com | Com | Com | Com | Com | Com | Com |
|---|---|---|---|---|---|---|---|---|---|---|
| (parts by weight) | | Ex. 1 | Ex. 2 | Ex. 3 | Ex. 4 | Ex. 5 | Ex. 6 | Ex. 7 | Ex. 8 | Ex. 9 |
| Coating | Acrylic component | 58.20 | 96.00 | 87.12 | 68.80 | 82.54 | 71.81 | 80.08 | 77.60 | 77.60 |
| solution of | Hyperbranched | 21.20 | 0.55 | 0.00 | 20.40 | 11.27 | 9.81 | 10.94 | 10.60 | 10.60 |
| photopoly- | acrylic resin | | | | | | | | | |
| merization | Silicone component | 11.60 | 0.30 | 6.51 | 5.14 | 0.00 | 12.60 | 5.99 | 5.80 | 5.80 |
| resin | Silica particles | 6.00 | 0.15 | 3.37 | 2.66 | 3.19 | 2.78 | 0.00 | 3.00 | 3.00 |
| composition | (30 nm) | | | | | | | | | |
| | Initiator | 3.00 | 3.00 | 3.00 | 3.00 | 3.00 | 3.00 | 3.00 | 3.00 | 3.00 |
| | (Subtotal) | 100.00 | 100.00 | 100.00 | 100.00 | 100.00 | 100.00 | 100.00 | 100.00 | 100.00 |
| | Solvent | 100.00 | 100.00 | 100.00 | 100.00 | 100.00 | 100.00 | 100.00 | 100.00 | 100.00 |

### Comparative Examples 8 and 9

Hard coat films of Comparative Examples 8 and 9 were produced under the same conditions as in Example 1 except that the number of the functional groups in the hyperbranched acrylate resin was changed from 16 to 8 and 18.

“Pencil hardness measurement,” a “scratching resistance test,” a “curling evaluation test,” a “transparency test,” “contact angle measurement,” a “permanent marker ink repellency test,” and a “test of the ease of wiping fingerprints off” described below were performed using the hard coat films of Examples 1 to 19 and Comparative Examples 1 to 9.

### [Pencil Hardness Measurement]

Each hard coat film was left to stand under the conditions of a temperature of 25° C. and a relative humidity of 60% for 2 hours. Subsequently, pencil hardness measurement was performed using a test pencil stipulated in JIS-S-6006 according to a method stipulated in JIS-K-5400.

### [Scratching Resistance Test]

The surface of the hard coat layer of each hard coat film was rubbed with steel wool #0000 under different loads, and the changes in appearance were visually observed and evaluated in the following three grades.

A: Not scratched.

B: Slightly scratched.

C: Scratched.

The measurement was performed by changing the load from 200 g, to 500 g, 1000 g, and 2000 g.

### [Curling Evaluation Test]

A sample prepared by cutting each hard coat film into a square shape of 100 mm×100 mm was placed on a flat glass plate with the hard coat layer facing up. The distances (mm) from the glass plate to the four corners of the sample were measured, and the average of the measurements was used as the degree of curling. A sample having a large degree of curling was rolled into a tubular shape, and the degree of curling of such a sample was not measured.

### [Transparency Test]

The transmittance of each hard coat film was measured using a spectrophotometer (product name: “U-4100” available from Hitachi Ltd.).

### [Contact Angle Measurement]

The water contact angle of each hard coat film was measured by a method stipulated in JIS K2396. The larger the water contact angle, the higher the antifouling properties.

### [Permanent Marker Ink Repellency Test]

Lines were drawn on the surface of the hard coat layer of each hard coat film with an oil-based permanent marker (product name: “Sharpie F” available from Sanford). The drawn lines were visually observed to determine whether or not the ink of the permanent marker was repelled, and the results were evaluated in the following three grades.

A: Repelled. The ink marks do not remain.

B: Slightly repelled. The ink marks remain.

C: Not repelled.

### [Test of the Ease of Wiping Fingerprints Off]

After the surface of the hard coat layer of each hard coat film was marked with fingerprints, the marked surface was wiped with tissue paper or BEMCOT (registered trademark) (available from ASAHI KASEI FIBERS CORPORATION) and was visually observed to determine the presence or absence of remaining fingerprint marks. The results were evaluated in the following three grades.

A: Wiped off.

B: The marks remain slightly visible.

C: Not wiped off.

The measurement and evaluation results are listed in Table 3 below.

TABLE 3
Evaluation results

| | | | | | | | | | Permanent | Ease of |
|---|---|---|---|---|---|---|---|---|---|---|
| | | Resistance to scratching | | | | | Trans- | Contact | marker | wiping |
| | Pencil | 250 g | 500 g | 1000 g | 2000 g | Curling | parency | angle | ink | fingerprints |
| | hardness | load | load | load | load | mm | % | degree | repellency | off |
| Ex. 1 | 4H | A | A | A | A | 12 | 93.0 | 102.0 | A | A |
| Ex. 2 | 4H | A | A | A | A | 14 | 93.0 | 102.0 | A | A |
| Ex. 3 | 4H | A | A | A | A | 16 | 93.0 | 102.0 | A | A |
| Ex. 4 | 4H | A | A | A | A | 14 | 93.0 | 102.0 | A | A |
| Ex. 5 | 4H | A | A | A | A | 18 | 93.0 | 102.0 | A | A |
| Ex. 6 | 4H | A | A | A | A | 18 | 93.0 | 102.0 | A | A |
| Ex. 7 | 4H | A | A | A | A | 12 | 93.0 | 102.0 | A | A |
| Ex. 8 | 4H | A | A | A | A | 16 | 93.0 | 102.0 | A | A |
| Ex. 9 | 4H | A | A | A | A | 16 | 93.0 | 102.0 | A | A |
| Ex. 10 | 4H | A | A | A | A | 16 | 93.0 | 102.0 | B | B |
| Ex. 11 | 4H | A | A | A | A | 16 | 93.0 | 102.0 | A | A |
| Ex. 12 | 4H | A | A | A | A | 16 | 93.0 | 102.0 | A | A |
| Ex. 13 | 4H | A | A | A | A | 16 | 93.0 | 102.0 | A | A |
| Ex. 14 | 4H | A | A | A | A | 18 | 93.0 | 102.0 | A | A |
| Ex. 15 | 4H | A | A | A | A | 16 | 93.0 | 102.0 | A | A |
| Ex. 16 | 4H | A | A | A | A | 16 | 93.0 | 102.0 | A | A |
| Ex. 17 | 4H | A | A | A | A | 16 | 93.0 | 102.0 | A | A |
| Ex. 18 | 4H | A | A | A | A | 16 | 93.0 | 102.0 | A | A |
| Ex. 19 | 4H | A | A | A | A | 16 | 93.0 | 102.0 | A | A |
| Com | 3H | A | A | A | A | 10 | 93.0 | 102.0 | A | A |
| Ex. 1 | | | | | | | | | | |
| Com | 4H | A | A | A | A | 24 | 93.0 | 102.0 | A | A |
| Ex. 2 | | | | | | | | | | |
| Com | 4H | A | A | A | A | 22 | 93.0 | 102.0 | A | A |
| Ex. 3 | | | | | | | | | | |
| Com | 3H | A | A | A | A | 10 | 93.0 | 102.0 | A | A |
| Ex. 4 | | | | | | | | | | |
| Com | 4H | A | A | B | C | 16 | 93.0 | 92.0 | C | C |
| Ex. 5 | | | | | | | | | | |
| Com | 3H | A | A | A | A | 16 | 93.0 | 102.0 | A | A |
| Ex. 6 | | | | | | | | | | |
| Com | 4H | A | A | B | C | 16 | 93.0 | 102.0 | A | A |
| Ex. 7 | | | | | | | | | | |
| Com | 3H | A | A | A | A | 18 | 93.0 | 102.0 | A | A |
| Ex. 8 | | | | | | | | | | |
| Com | 3H | A | A | A | A | 25 | 93.0 | 102.0 | A | A |
| Ex. 9 | | | | | | | | | | |

As can be seen from the results of Examples 1 to 3 in Table 3, when the thickness of the hard coat layer of the present invention is 6.0 μm or more and 12.0 μm or less, preferred results can be obtained.

As can be seen from the results of Examples 4 and 5 and Comparative Examples 1 and 2, when the amount of the acrylic component in the photopolymerizable resin composition is 65.0 percent by weight or more and 95.0 percent by weight or less, preferred results can be obtained.

As can be seen from the results of Examples 6 and 7 and Comparative Examples 1 to 4, when the amount of the hyperbranched acrylate resin in the photopolymerizable resin composition is 2.0 percent by weight or more and 20.0 percent by weight or less, preferred results can be obtained.

As can be seen from the results of Examples 8 and 9 and Comparative Examples 2, 5, and 6, when the amount of the silicone component in the photopolymerizable resin composition is 0.5 percent by weight or more and 12.0 percent by weight or less, preferred results can be obtained.

As can be seen from the results of Examples 10, 11, and 19 and Comparative Examples 2 and 7, when the photopolymerizable resin composition contains silica particles and the amount thereof is 0.5 percent by weight or more and 6.0 percent by weight or less, preferred results can be obtained.

As can be seen from Examples 12 and 13, when the silica particles contained in the hard coat layer of the present invention have a particle size (average particle size) of 10 nm or more and 50 nm or less, the transparency, the permanent marker ink repellency, and the ease of wiping fingerprints off are good.

As can be seen from Examples 1 and 14 and Comparative Examples 8 and 9, when the number of the functional groups in the hyperbranched acrylate resin contained in the hard coat layer of the present invention is 9 or more and 16 or less, preferred results can be obtained.

As can be seen from Example 15, no particular limitation is imposed on the resin film used in the present invention. Preferred results can also be obtained when a film made of a material other than triacetylcellulose is used.

In Examples 1 and 16 to 18 in which the number of the functional groups in the acrylic component was changed in the range of from 6 to 15, all the results for the pencil hardness, the scratching resistance, the curling, the transparency, the contact angle, the permanent marker ink repellency, and the ease of wiping fingerprints off were good.

### INDUSTRIAL APPLICABILITY

The present invention is useful as a technique for forming a protective layer on the surface of a display such as a CRT, LCD, PDP, FED, or organic EL, a touch panel of a home electric appliance, glass, or the like.

1. An ionizing ray polymerizable resin composition for forming a hard coat layer, the composition comprising:
65 parts by weight or more and 95 parts by weight or less of an acrylic component that is a urethane oligomer having a linear main skeleton or a main skeleton having one branch point;
0.5 parts by weight or more and 12 parts by weight or less of a silicone component including one or both of a silicone monomer having an acryloyl group at a terminal thereof and a silicone oligomer having an acryloyl group at a terminal thereof;
2 parts by weight or more and 20 parts by weight or less of a hyperbranched acrylate resin having 2 or more branch points in a main skeleton thereof and having 9 or more and 16 or less functional groups in a chemical structure thereof; and
0.5 parts by weight or more and 6 parts by weight or less of silica particles.

2. A hard coat film, comprising a resin film and a hard coat layer disposed on a surface of the resin film, wherein
the hard coat layer is a cured product of an ionizing ray polymerizable resin composition, the cured product being produced by curing the ionizing ray polymerizable resin composition by exposure to ionizing rays, the ionizing ray polymerizable resin composition comprising:
65 parts by weight or more and 95 parts by weight or less of an acrylic component that is a urethane oligomer having a linear main skeleton or a main skeleton having one branch point;
0.5 parts by weight or more and 12 parts by weight or less of a silicone component including one or both of a silicone monomer having an acryloyl group at a terminal thereof and a silicone oligomer having an acryloyl group at a terminal thereof;
2 parts by weight or more and 20 parts by weight or less of a hyperbranched acrylate resin having 2 or more branch points in a main skeleton thereof and having 9 or more and 16 or less functional groups in a chemical structure thereof; and
0.5 parts by weight or more and 6 parts by weight or less of silica particles.

3. The hard coat film according to claim 2, wherein the hard coat layer has a thickness of 6 mm or more and 12 mm or less.

4. The hard coat film according to claim 2, wherein an average particle size of the silica particles is 10 nm or more and 50 nm or less.

5. The hard coat film according to claim 3, wherein an average particle size of the silica particles is 10 nm or more and 50 nm or less.
